(19) United States
(12) Patent Application Publication
(10) Pub. No.: US 2003/0018517 A1
(43) Pub. Date: Jan. 23, 2003

(54) Providing marketing decision support

(76) Inventors: Stephen F. Dull, Atlanta, GA (US); Neil K. Allison, Scottsdale, AZ (US)

Correspondence Address: FISH & RICHARDSON P.C., 45 ROCKEFELLER PLAZA, SUITE 2800, NEW YORK, NY, 10111, US

(21) Appl. No.: 09/909,955

(22) Filed: Jul. 20, 2001

(51) Int. Cl. G06F 17/60

(52) U.S. Cl. 705/10

(57) ABSTRACT

A method includes receiving at least conjoint survey data concerning consumer experience with a brand. The data is processed to produce marketing analytics, the marketing analytics are presented to a user so that a decision can be made.

### BACKGROUND

The invention relates to providing marketing decision support.

Many companies that provide products and services over traditional marketing channels have begun to establish their presence on the World Wide Web (Web) by marketing over a Website. These companies are faced with many tasks including ascertaining the impact the Web has on the total customer Web experience and building their product brands on the Web.

Companies often need to make marketing decisions related to improving their customer's Web experience. These marketing decisions may require having marketing data such as the value the customer places on specific changes to a Website, the willingness of the customer to pay for incremental benefits and other marketing data. The companies also may need to continuously track and measure the strength of their brand experience on the Web as they make marketing decisions that impact their Website. To make effective marketing decisions, the companies may need to gather data that compares the different brands across competitors and industries and data that provides a measure of the growth of customer loyalty.

### SUMMARY

In one aspect, the present invention provides a method that includes receiving at least conjoint survey data concerning consumer experience with a brand, processing at least the conjoint survey data to produce marketing analytics, and presenting the marketing analytics in at least one of a plurality of selectable forms to allow a user to make a decision.

The aforesaid method may include receiving at least one of a traditional survey data, company profitability data, market share data, consumer behavioral data and product catalog data. The marketing analytics can be displayed in a form specified by a user and conjoint survey data can be updated at predetermined intervals. A presentation engine can be used to provide a variety of display choices to a user. The method can generate simulation data using the marketing analytics. The marketing analytics can include at least one of a utility analytic, a trend analytic, an attribute importance analytic, a competitive advantages and opportunities analytic, and an improvement opportunities analytic.

In a second aspect, the invention provides an apparatus configured to perform the methods disclosed above.

In a third aspect, the invention provides an article comprising a computer-readable medium that stores computer executable instructions for causing a computer system to perform the methods disclosed above.

In a fourth aspect, the present invention provides a method that includes accessing a system that is configured to process marketing analytics and provide a variety of selectable display choices, wherein the marketing analytics are based on at least conjoint survey data concerning consumer experience with a brand, selecting a display choice, and viewing the marketing analytics in response to the selection.

The above method may include accessing the system over a network and requesting simulations based on the marketing analytics. The marketing analytics can include at least one of a utility analytic, a trend analytic, an attribute importance analytic, a competitive advantages and opportunities analytic, and an improvement opportunities analytic.

In a fifth aspect, the invention provides an apparatus configured to perform the methods disclosed above.

In a sixth aspect, the invention provides an article comprising a computer-readable medium that stores computer executable instructions for causing a computer system to perform the methods disclosed above.

In a seventh aspect, the invention provides a tool an analytic engine for processing at least conjoint survey data regarding at least one brand and for grouping the processed data according to a plurality of marketing analytics, and a presentation engine for displaying the marketing analytics based on a user selection.

The above tool may include using the presentation engine to perform simulations based on at least one marketing analytic. The marketing analytics can include at least one of a utility analytic, a trend analytic, an attribute importance analytic, a competitive advantages and opportunities analytic, and an improvement opportunities analytic. The analytic engine can process at least one of traditional survey data, company profitability data, market share data, consumer behavioral data and product catalog data.

The foregoing techniques can provide the user the ability to track and measure the strength of brand experience allowing the user to make decision regarding the brand, both online and offline. The techniques produce marketing analytics using various data sources including conjoint survey data. Conjoint survey data is based on a statistical technique that asks the customer a series of dynamic product comparison questions which forces the customer to make tradeoffs between different product and service attributes. The various data sources are used to produce marketing analytics that allow the user to make informed marketing decisions. It also can provide the user with strategic insight into the strength of the customer's Web experience, the greatest opportunities for improvement, what customers value most in an online experience and how best to deliver against that.

The marketing analytics includes data that can provide the user with insights for making internal operations and investment decisions. For example, the marketing analytics can aid the user in deciding how to make an optimal profitable Website investment, what are the tradeoffs between customer preferences and profitability and what are the tradeoffs between market share and profitability.

Moreover, the marketing analytics can provide the user with competitive data for making decisions on how to build an online competitive advantage and how to differentiate the user's online brand Web experience from a competitor's Web experience.

The marketing analytics also can provide the user with data related to conversion along a marketing funnel. This data allows the user to determine at what stage the customer is along the marketing funnel and how to increase the conversion along the marketing funnel.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is a simplified block diagram of a computer network system according to an implementation of the invention.

FIG. 2 is a simplified block diagram of a business computer system according to an implementation of the invention.

FIG. 3 is a data source according to an implementation of the invention.

FIG. 4 is a flow chart according to an implementation of the invention.

FIG. 5 is a flow chart according to an implementation of the invention.

FIGS. 6A-6J are simplified example screenshots according to an implementation of the invention.

Like reference symbols in the various drawings indicate like elements.

### DETAILED DESCRIPTION

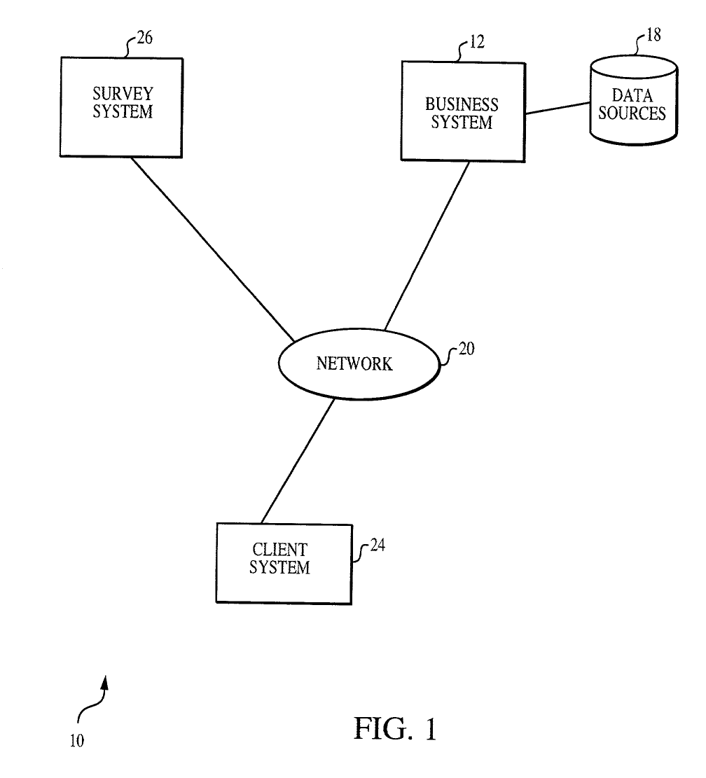

FIG. 1 shows a computer network system 10 in which a user may access a business system 12 using a client system 24 such as a personal computer (PC) connected to a network 20. The network 20 can include the Internet, the World Wide Web (Web) or other network. The business system 12 allows the user such as a company with a Website to track and measure the strength of a customer's Web experience. The business system also gathers information related to the Web experience such as customer's attitude and reaction to the user's Website compared to a competitor's Website.

The business system 12 includes techniques for analyzing data from data sources, for producing marketing analytics based on the data and for presenting the marketing analytics to the user who is then able to make marketing decisions. Marketing analytics include data that can provide the user with strategic insight into the marketing business environment, the internal operations and investments, the competition, and conversion along the marketing funnel. The marketing funnel is a range of stages representing a customer's awareness of the user's product which can vary from just being aware of the product to being totally committed to the product. The business system 12 can provide the user with the tools to make a marketing decision such as whether a change in a product or service offering on the user's Website will increase consumer preference and/or sales.

A survey system 26 can be a computer such as a server computer that communicates with the business system 12 and provides survey data. The survey data is sent to the business system 12 to be stored in the data source 18. The data source 18 is later retrieved and used by the business system 12 for generating marketing analytics. Alternatively, the survey data can be produced by the business system 12. Such survey data can include conjoint survey data and traditional survey data. The survey system 26 can provide a unique panel of respondents who participate in each type of survey. The survey data will be discussed in detail below.

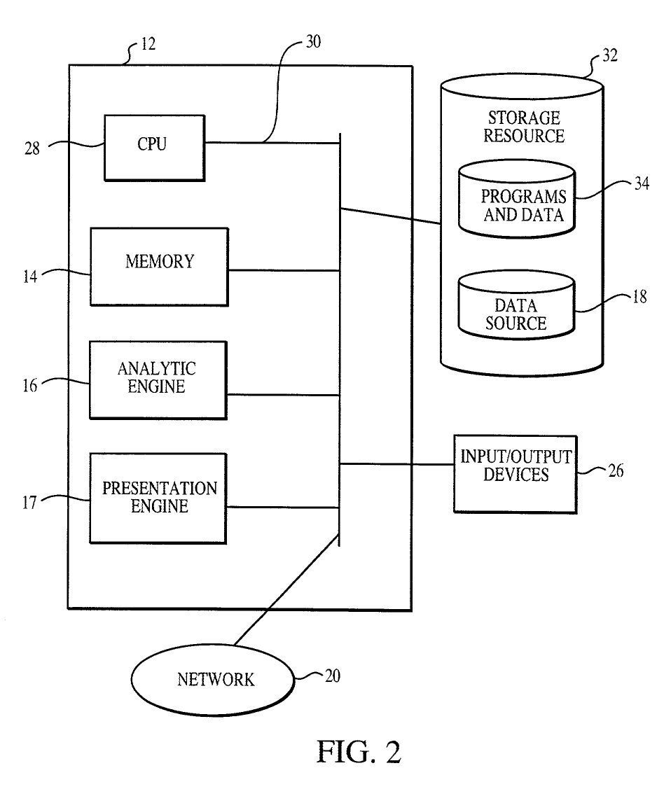

FIG. 2 shows a business system 12 according to an embodiment of the invention. The business system 12 can be a server computer such as an Internet information server (IIS) or other server computer. The business system 12 includes a bus 30 that is connected to a central processing unit (CPU) 28 and to a memory 14. The CPU 28 is capable of executing programs residing in memory 14 and processing data stored in memory. Such a CPU 28 can include an Intel Pentium Processor or other processor. The memory 14 can include read only memory (ROM), random access memory (RAM), static random access memory (SRAM), dynamic random access memory (DRAM) or other memory.

A storage resource 32 is connected to the business system 12 through the bus 30 and can be used to store the data source 18. The storage resource 32 is also capable of storing programs and data 34 such as an operating system (OS), device drivers or other programs and data. The storage resource 32 can be include any device capable of holding large amounts of data, such as a hard drive, compact disk read-only (CD-ROM), redundant array of inexpensive drives (RAID) or other storage device.

Input/output (I/O) devices 26 can include hardware and software components such as a keyboard that allow data to be input to the business system 12. In addition, I/O device 26 can include a display monitor that displays data from the business system 12 or a printer for creating a hard copy of data from the business system. The business system 12 connects to the network 20 through the use of a combination of software elements such as device drivers and hardware elements such as a network interface adapter.

The business system 12 includes an analytic engine 16 which is used to analyze the data from various source including the data stored in the data source 18 and to produce various marketing analytics based on the data. A presentation engine 17 is used to present the various marketing analytics to a user connected to the business system 12. The presentation engine 17 also can provide the user the ability to perform “what-if” simulations based on the marketing analytics. The simulations can include generating simulated marketing data based on input hypothetical data that is proposed by the user. By using the hypothetical data, the user is able to evaluate the impact the data may have on various marketing parameters such as market share, profitability or other marketing parameters. The analytic and the simulation data can be stored in the storage resource 32 for later retrieval. The analytic engine 16 and the presentation engine 17 can be implemented as a combination of hardware elements residing on the business system 12 and software elements stored in memory 14 or in the storage resource 32.

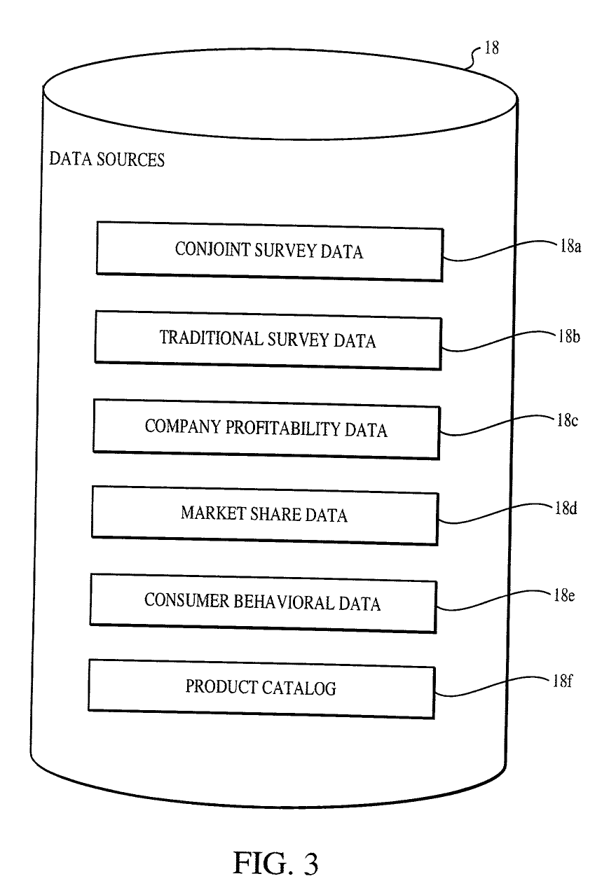

FIG. 3 shows a data source 18 according to an implementation of the invention. The data source 18 includes various sources of data that are used by business system 12 for generate marketing analytics. The data source 18 can be maintained in a database such as Oracle, Microsoft SQL server or other database. The data stored in the data source 18 can be updated continuously or in real-time as the data is gathered. In addition, the data source can be updated at predetermined time periods such as daily, weekly, quarterly or some other predetermined time period.

The data source 18 may also include conjoint survey data 18a which is based on a statistical technique known as conjoint analysis. The technique is based on adapting questions based on a consumer's response over time. The technique also relies on a series of dynamic comparison questions which enables a respondent participating in the conjoint survey to make tradeoffs among product or service attributes. For example, an online financial services company may offer services such as free market research and low fee online trading. The respondent may be asked questions regarding the attribute “free market research” and whether it is important relative to the attribute “low fee online trading”. The technique elicits increasing levels of clarity regarding the relative importance of the factors that influence a consumer's online or offline purchasing decision. The attributes and levels that are designed into the survey make up the “factors” that are traded off in the hypothetical scenarios.

The data source 18 may also include traditional survey data 18b. Traditional survey data 18b can be created by asking a panel of respondents participating in the survey questions that are open-ended or multiple-choice in nature. The answers to the questions capture parameters related to demographic information about the panel of respondents. Such parameters can include age, gender, income or other parameters. The traditional survey data 18b also can include information related to a customer's awareness, usage, and attitudes towards certain brands.

The data source 18 may include company profitability data 18c for each company that subscribes to the business system 12. As discussed below, the profitability data 18c is used by the analytic engine 16 and the presentation engine 17 for profitability related calculations and “what-if” simulations. Although the company profitability data 18c is used by the business system 12, the data is kept private and not shared among participating subscribing companies.

The data source 18 may also include market share data 18d. The market share data 18d is statistical data that provides a measurement of the market share of the top firms in each industry. The market share data 18d can be gathered from a public source of information and can be shared among the subscribers to the business system 12. As discussed below, the market share data 18d can be used by the analytic engine 16 and the presentation engine 17 for generating market share related calculations and for “what-if” simulations.

The data source 18 can include consumer behavioral data 18e. It is relatively easy to gather data concerning a consumer's purchasing decisions regarding all sorts of products and services. However, it is more difficult to determine the reasons behind the consumer's purchasing decision. The consumer behavioral data 18e provides possible reasons related to a consumer's purchasing decision. The consumer behavioral data 18e can be gathered from a public source or can be provided by a subscriber or user to the business system 12.

The data source 18 also may include a product catalog 18f that can contain information related to product or services offered by a particular company. The information can include the key attributes of each product and the range of values for each attribute. For example, in a breakfast cereal industry, a breakfast cereal company could have a website providing product information related to the cereals produced by the company. The product information could include the types of cereal offered by the company and attributes associated with each cereal such as the amount of product information and brand familiarity with the cereals.

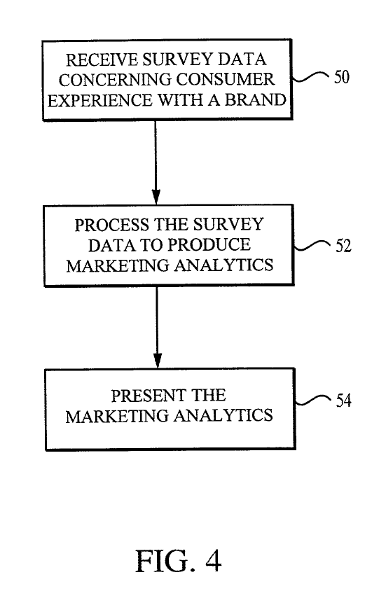

FIG. 4 is a simplified flow chart detailing a method according to a particular embodiment of the invention. The business system 12 receives 50 survey data concerning websites of an industry from the data source 18. In one embodiment, the business system receives conjoint survey data concerning a consumer's experience with an online brand or and traditional brand. The survey data includes the conjoint survey data 18a and the traditional survey data 18b. The business system 12 may also input data from the data source 18 including company profitability data 18c, market share data 18d, consumer behavioral data 18e, product catalog data 18f or other data.

Once the business system 12 receives (block 50) the survey data, it processes the data to produce marketing analytics. The business system 12 uses the analytic engine 16 to produce various analytics which can provide the user with information for making marketing decisions. The various analytics are discussed in detail below.

After the business system 12 produces (block 52) the marketing analytics, the business system displays 54 the analytics to a user. The business system 12 uses the functionality of the presentation engine 17 to provide the user with the ability to select a particular display from one or more display options. The presentation engine 17 provides the user the ability to perform “what-if” simulations using the marketing analytics. Various “what-if” simulations are discussed below in detail. In one embodiment, the business system 12 presents the marketing analytics so that a user can make decisions regarding a brand, whether it's an online brand or traditional brand.

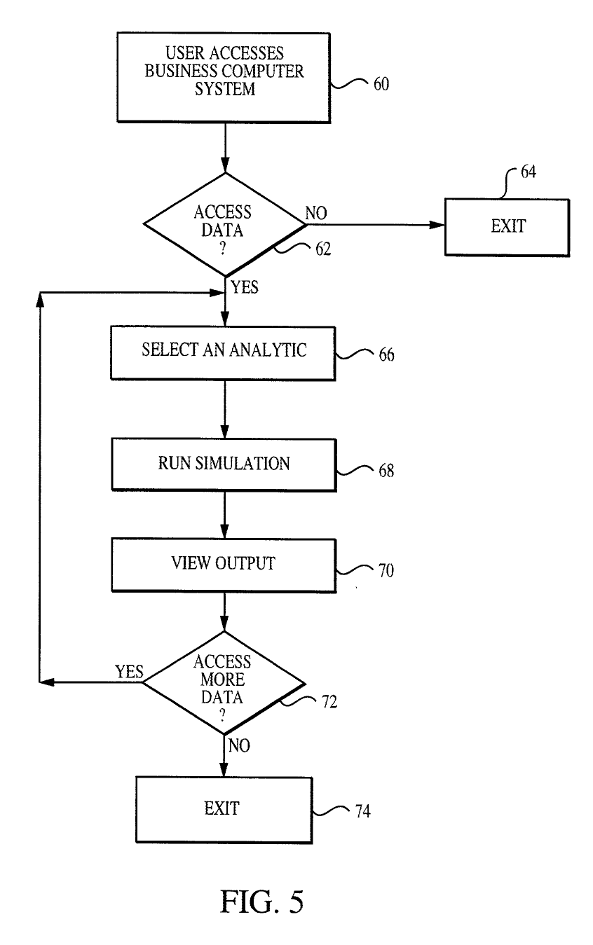

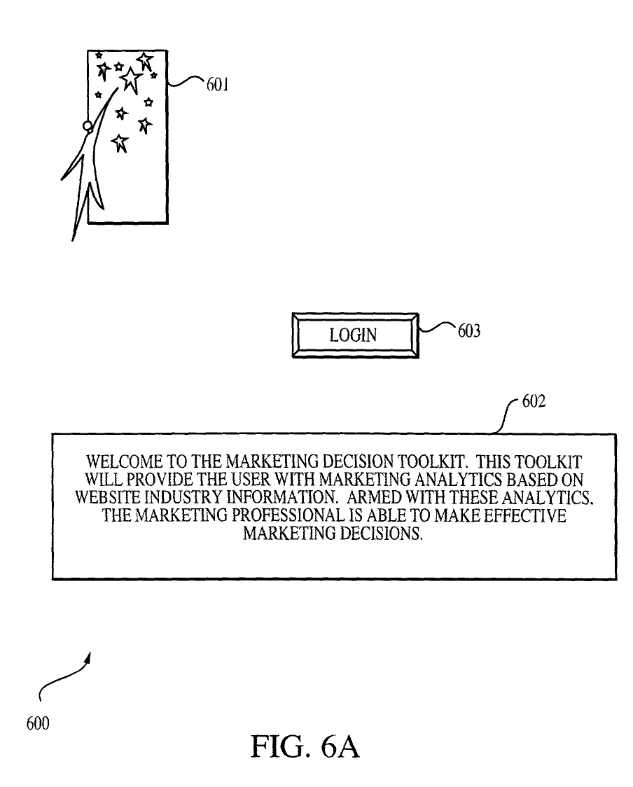

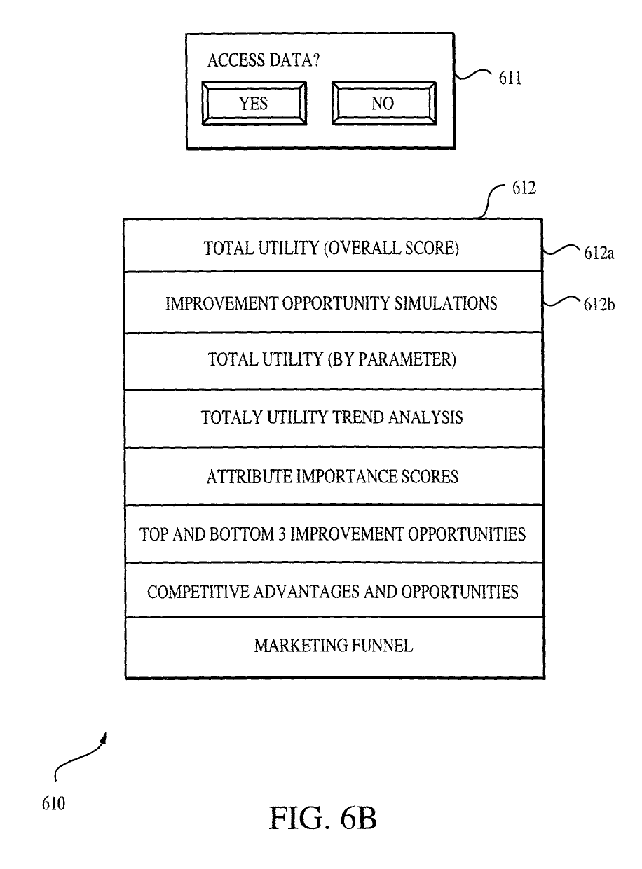

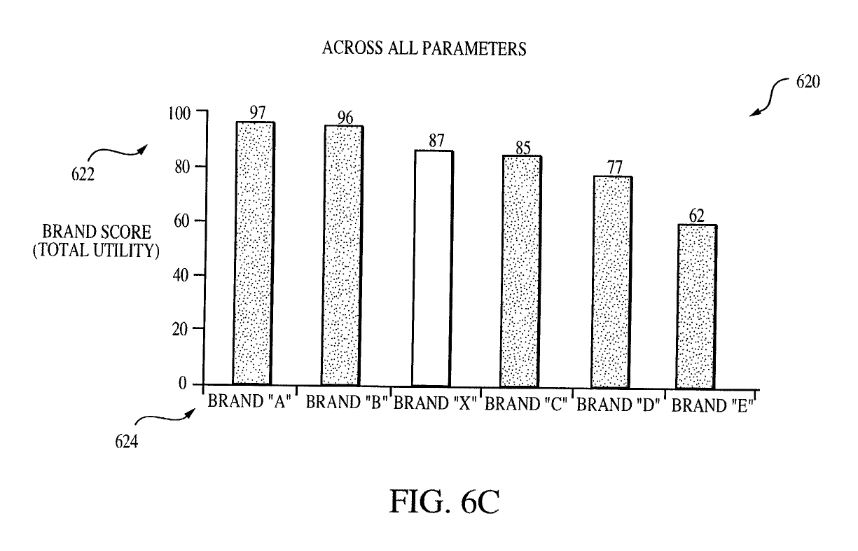

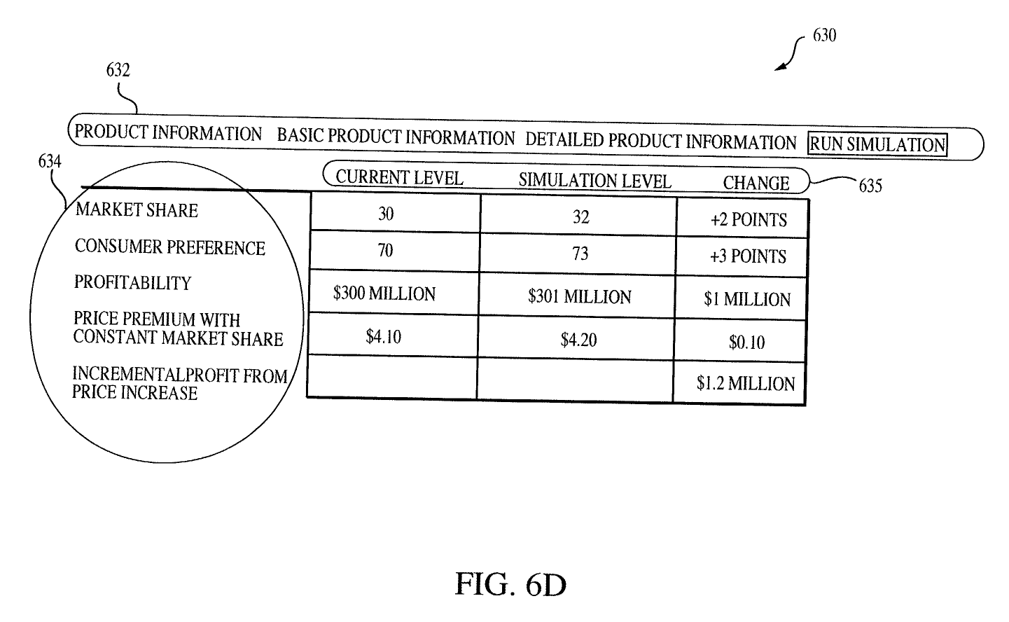

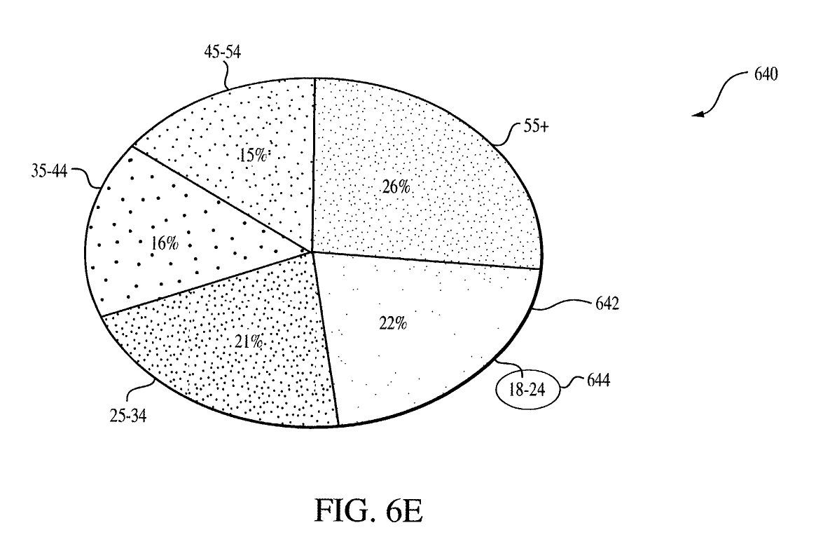

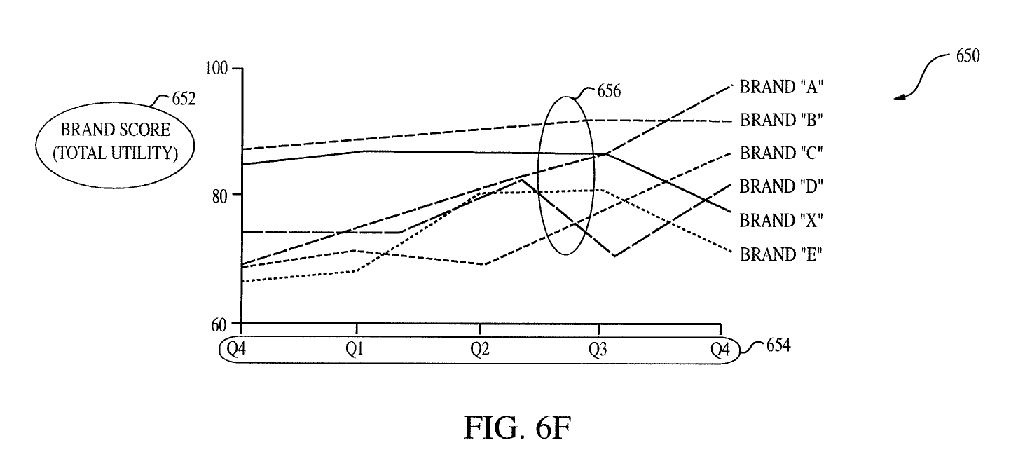

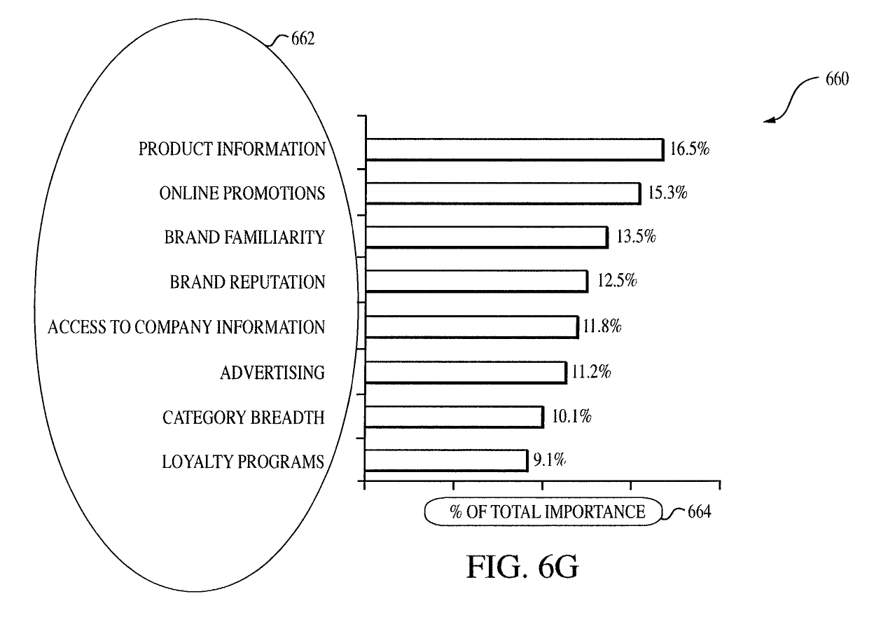

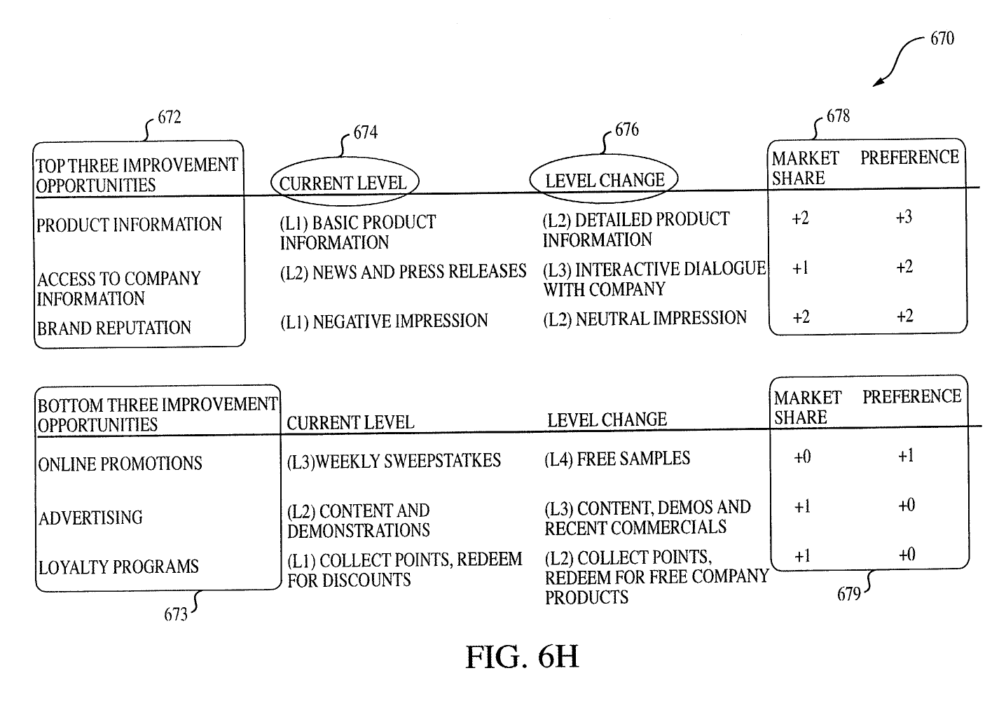

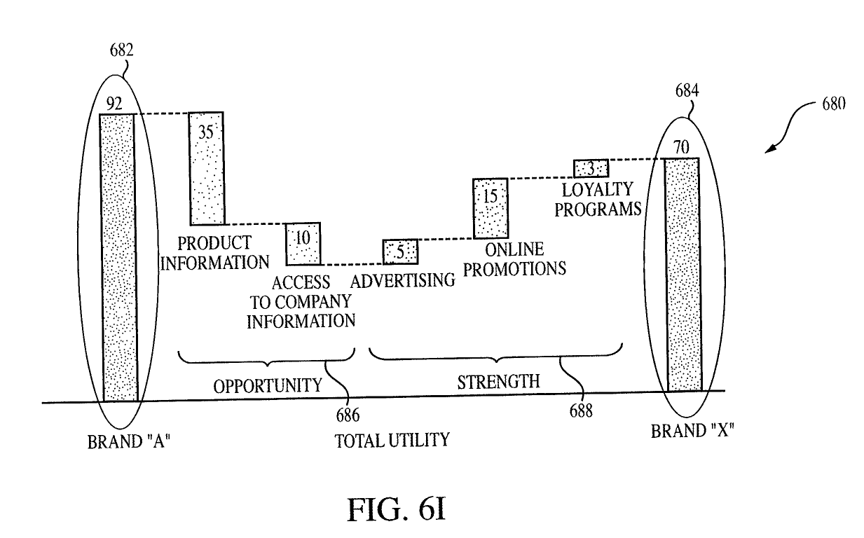

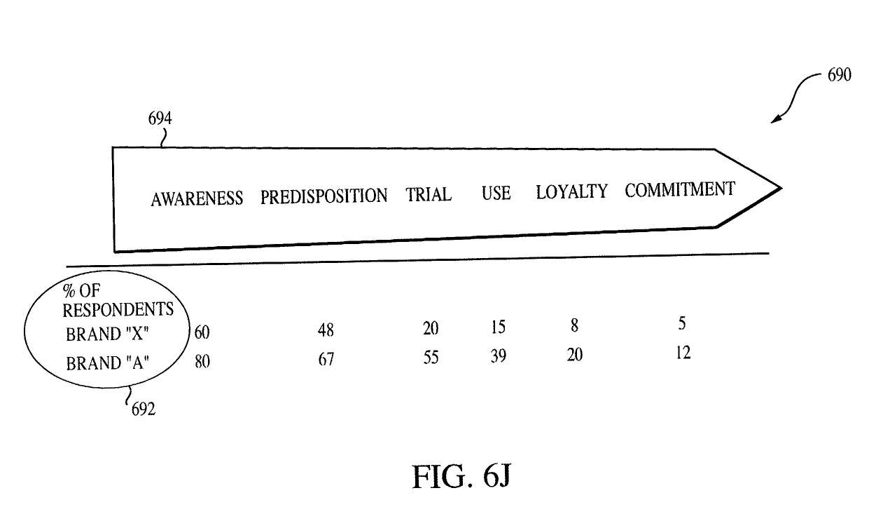

FIG. 5 is a flow chart illustrating a method in which a user interacts with a particular embodiment of the business system 12. The user accesses 60 the business system 12 through a login screen 600 illustrated in FIG. 6A. The login screen 600 can include a company's logo 601, a message 602 containing information about the business system 12, and a field 603 for entering user identification information such as a username, password or other identification information. The business system 12 determines whether the user is authorized to access the system. If the user is not authorized to access the business system 12, the user is then denied access to the business system.

Once the business system 12 has authorized the user access to the system, it can display a data access screen 610 as illustrated in FIG. 6B. The data access screen 610 contains an access button 611 which provides the user with the option of accessing 62 analytic data and simulation data or exiting 64 the business system 12. The screen 610 contains a list of analytics 612 that can be selected by the user.

The user can select 66 a particular analytic from a dropdown box list of analytics 612. For example, if the user selects the total utility analytic 612a from the list 612, the business system 12 displays the total utility screen shot 620 as shown in FIG. 6C. The total utility analytic screen shot 620 is a bar graph that graphically illustrates the average total utility 622 for a range of products 624 in a particular industry.

The average total utility 622 is determined by first calculating the utility for each product. The utility is based on the values the respondents to the conjoint survey placed on an each attribute of each product. The product information is obtained from the product catalog 18f and the utility information is obtained from the conjoint survey data 18a. Second, each utility value produced by each respondent is then divided by the number of respondents. The total utility analytic provides a measurement that allows the user to evaluate at the highest level the brand performance of the user's product compared to a competitor's product. For example, “Brand A” has the highest utility represented by the value 97 while the “Brand E” has the lowest utility represented by the value 62.

Once the user has selected (block 66) a particular analytic, the user can select to run 68 a “what-if” simulation using the selected analytic. This type of analytic can provide the user with quantitative marketing information such as recommendations and actionable insights for making marketing decisions. It allows the user to evaluate the impact a marketing decision may have on customer preference for a brand, profitability, market share and conversion of the customer along a marketing funnel.

For example, the user can select the improvement opportunity analytic 612b from the list of analytics 612. The business system 12 responds by displaying a screen shot 630 shown in FIG. 6D representing the improvement opportunity analytic 612b. An attribute row 632 lists the attributes of a product or service offered by the user. The parameter column 634 lists the various financial parameters that the user would like to measure in response to changing a value in the attribute row 632. The resultant columns 635 shows the impact a change in an attribute 632 has on each parameter in the financial parameter column 634. For example, the improvement opportunity analytic 630 shows how changing the “product information” attribute 632 from “basic product information” to “detailed product information” impacts the values in the financial parameters 634.

As a result of increasing the amount of production information offered, market share increases from a current market share level of 30 to a simulation market share level of 32 for a total increase of 2 points. Similarly, customer preference increases by 3 points and profitability increases by $1.0 million. In addition, the simulation reveals that an increase in the price premium with constant market share from $4.10 to $4.20 results in an incremental profit of $1.2 million. To generate the marketing analytic, the business system uses data from the data source 18 such as conjoint survey data 18a, company profitability data 18c, market share data 18d and product catalog data 18f.

Once the analytics have been generated (blocks 66 and 68), the user can view 70 the output. The business system 12 provides the user with the ability to select the format of the output. Such output formats can include output to a display such as the screen shots discussed above, output directed to a printer, output stored in a file or other output formats. Once the user views the output (block 70), the user has the option to access 72 more analytic related data or exit 74 the business system 12.

FIGS. 6E-6J illustrate additional marketing analytics screen shots that the business system 12 can produce. FIG. 6E illustrates a total utility marketing analytic 640 which uses a pie chart to show the percentage of the respondents 642 for a particular parameter level 644. In this example, the screen shot 640 shows the percentage of respondents 642 broken down by an age parameter level 644. The parameter levels 644 also can include gender, income or other parameter levels. This analytic provides further insight into the user's performance by showing the percentage of respondents corresponding to a particular parameter level.

FIG. 6F shows a total utility trend marketing analytic screen shot 650 which is a line graph representing how product scores 652 change over a time period 654. The product scores 652 are based on the total utility of different products 656 over a period of time 654 such as over a quarter. This analytic allows the user to track brand performance over a period of time and determine whether the past marketing decisions were effective in achieving a certain marketing goal.

FIG. 6G is a screen shot of an attribute importance score marketing analytic 660 implemented as a bar graph. This analytic shows various attributes 662 of a product offered by the user compared to the percentage of total importance 664 consumers have placed on each attribute. The total importance 664 is calculated using various data sources including the conjoint analysis survey data 18a and the traditional survey data 18b. The total importance calculations can be based on different parameters such as age, income or other parameters. This analytic can provide the user with the ability to evaluate what attributes of the web experience are important to consumers.

FIG. 6H is a screen shot depicting a marketing analytic 670 that illustrates a top and bottom three improvement opportunities. The top three opportunities column 672 lists the attributes that will be most impacted while the bottom three opportunities column 673 list the attributes that have the least impact on marketing performance. The current level column 674 and indicates the current level of the attribute and the level change column 676 shows the change in the attribute. The top financial attribute columns 678 lists the financial parameters that will most benefit from the changes in the attributes shown in the top attribute column 672. In contrast, the bottom financial attribute columns 679 lists the financial parameters that will least benefit from the changes in the attributes shown in the bottom attribute column 673.

For example, one of the top three improvement opportunities involves changing the product information attribute. If the user increases the product information attribute from a current level of “Basic product information” to a “detailed product information” level, the analytic indicates that market share may improve by +2 points and customer preference may improve by +3 points. In contrast, if the user decides to increase the online promotion attribute from a current level of “Weekly sweepstakes” to “free samples” level, market share may remain at the same as indicated by +0 points. Thus, this analytic generates simulation data based on hypothetical data which can provide the user with guidance on how best to make investment decisions such as how to allocate financial resources among several attractive alternatives.

FIG. 6I shows a competitive advantages and opportunities marketing analytic screen shot 680 in which a competitor's product 682 is compared to the users product 684. By using total utility calculations, the user's areas of strength 688 and the areas of opportunity 686 can be readily identified. For example, the areas of strength 688 for the user are in advertising, online promotion and loyalty programs. In addition, the analytic indicates that the user has several areas of opportunities 686 including product information and access to company information. The analytic can pinpoint the user's competitive advantage and opportunities allowing the user to make effective marketing decisions. For example, the user can exploit this opportunity information and decide to increase product information related to his product

FIG. 6J illustrates a marketing funnel analytic screen shot 690 which shows the percentage of respondents 692 along each stage of the marketing funnel 694. The marketing funnel 694 represents a range of stages indicating a customer's awareness of the user's product. The customer's awareness can vary from just being aware of the product to being totally committed to the product. The percentage of respondents 692 can be calculated by conducting a survey and classifying the total number of respondents who are “aware” or not “aware” of the user's product brand compared to the competitor's product, the total number is then divided by the total number of respondents who participated in the survey. This analytic uses data such as the conjoint survey data 18a and the traditional survey 18b in its calculations.

The marketing funnel analytic can help the user to focus on the impact past marketing efforts have had on a customer's stage along the marketing funnel. Additional analytics can include conversion of customers along the marketing funnel which can represent the change in the customer's awareness along the marketing funnel in response to changes in the user's marketing efforts. Moreover, other analytics can show the importance of a product attribute to a customer and whether the attribute affects the customer's stage along the marketing funnel.

Various features of the system may be implemented in hardware, software or a combination of hardware and software. For example, some aspects of the system can be implemented in computer programs executing on programmable computers. Each program can be implemented in a high level procedural or object-oriented programming language to communicate with a computer system. Furthermore, each such computer program can be stored on a storage medium, such as read-only-memory (ROM) readable by a general or special purpose programmable computer, for configuring and operating the computer when the storage medium is read by the computer to perform the functions described above.

Various modifications may be made. The actual format of the screens may be modified to reflect a particular user's desires. Additionally, the analytics and categories available may be modified. The system may be adapted to arrange the logical structure of the screens in alternate ways. Also, the physical arrangement of components and the system architecture of an actual system may vary from what has been detailed herein. Various system functions may be consolidated on one or more computers.

It is to be understood that while the invention has been described in conjunction with the detailed description thereof, the foregoing description is intended to illustrate and not to limit the scope of the invention. Other implementations are within the scope of the following claims.

What is claimed is:

1. A method comprising:
receiving at least conjoint survey data concerning consumer experience with a brand;
processing at least the conjoint survey data to produce marketing analytics; and
presenting the marketing analytics in at least one of a plurality of selectable forms to allow a user to make a decision.

2. The method of claim 1 further comprising receiving at least one of a traditional survey data, company profitability data, market share data, consumer behavioral data and product catalog data.

3. The method of claim 1 wherein the marketing analytics are displayed in a form specified by a user.

4. The method of claim 1 further comprising updating the conjoint survey data at predetermined intervals.

5. The method of claim 1 wherein a presentation engine is used to provide a variety of display choices to a user.

6. The method of claim 1 further comprising generating simulation data using the marketing analytics.

7. The method of claim 1 wherein the marketing analytics include at least one of a utility analytic, a trend analytic, an attribute importance analytic, a competitive advantages and opportunities analytic, and an improvement opportunities analytic.

8. An apparatus comprising:
a memory; and
a processor coupled to the memory, wherein the processor is configured to:
receive data including at least conjoint survey data concerning consumer experience with a brand,
process the data to produce marketing analytics, and
present the marketing analytics in at least one of a plurality of selectable forms so that a user can make a decision.

9. The apparatus of claim 8 wherein the data received by the processor further includes at least one of a traditional survey data, company profitability data, market share data, consumer behavioral data and product catalog data.

10. The apparatus of claim 8 wherein the processor is configured to display marketing analytics in a form specified by a user.

11. The apparatus of claim 8 wherein the processor is further configured to update the conjoint survey data at predetermined intervals.

12. The apparatus of claim 8 further comprising a presentation engine associated with the processor for providing a variety of display choices to a user.

13. The apparatus of claim 8 further comprising a presentation engine associated with the processor for generating simulation data using the marketing analytics.

14. The apparatus of claim 8 wherein the marketing analytics include at least one of a utility analytic, a trend analytic, an attribute importance analytic, a competitive advantages and opportunities analytic, and an improvement opportunities analytic.

15. An article comprising a computer-readable medium that stores executable instructions for causing a computer system to:
process data including at least conjoint survey data concerning consumer experience with a brand; and
present the marketing analytics in at least one of a plurality of selectable forms so that a user can make a decision.

16. The article of claim 15 further comprising instructions for causing the computer to process data including at least one of a traditional survey data, company profitability data, market share data, consumer behavioral data and product catalog data.

17. The article of claim 15 further comprising instructions for causing the computer to display the marketing analytics in a form specified by a user.

18. The article of claim 15 further comprising instructions for causing the computer to update the conjoint survey data at predetermined intervals.

19. The article of claim 15 further comprising instructions for causing the computer to process the marketing analytics using a presentation engine to provide a variety of display choices to a user.

20. The article of claim 15 further comprising instructions for causing the computer to generate simulation data using the marketing analytics.

21. The article of claim 15 wherein the marketing analytics include at least one of a utility analytic, a trend analytic, an attribute importance analytic, a competitive advantages and opportunities analytic, and an improvement opportunities analytic.

22. A method comprising:
accessing a system that is configured to process marketing analytics and provide a variety of selectable display choices, wherein the marketing analytics are based on at least conjoint survey data concerning consumer experience with a brand;
selecting a display choice; and
viewing the marketing analytics in response to the selection.

23. The method of claim 22 comprising accessing the system over a network.

24. The method of claim 22 further comprising requesting the system to perform simulations based on the marketing analytics.

25. The method of claim 22 wherein the marketing analytics include at least one of a utility analytic, a trend analytic, an attribute importance analytic, a competitive advantages and opportunities analytic, and an improvement opportunities analytic.

26. An apparatus comprising:
a memory; and
a processor coupled to the memory, wherein the processor is configured to:
access a system that is configured to process marketing analytics and provide a variety of selectable display choices, wherein the marketing analytics are based on conjoint survey data concerning consumer experience with a brand,
provide a selection of display choices, and
display the marketing analytics in response to the selection.

27. The apparatus of claim 26 wherein the processor is configured to access the system over a network.

28. The apparatus of claim 26 wherein the processor is configured to request a simulation based on the marketing analytics.

29. The apparatus of claim 26 wherein the marketing analytics includes at least one of a utility analytic, a trend analytic, an attribute importance analytic, a competitive advantages and opportunities analytic, and an improvement opportunities analytic.

30. An article comprising a computer-readable medium that stores executable instructions for causing a computer system to:
access a system that is configured to process marketing analytics and provide a variety of selectable display choices, wherein the marketing analytics are based on at least conjoint survey data concerning consumer experience with a brand;
provide a selection of display choices; and
display the marketing analytics in response to the selection.

31. The article of claim 30 further comprising instructions for causing the computer to access the system over a network.

32. The article of claim 30 further comprising instructions for causing the computer to request simulations based on the marketing analytics.

33. The article of claim 30 wherein the marketing analytics include at least one of a utility analytic, a trend analytic, an attribute importance analytic, a competitive advantages and opportunities analytic, and an improvement opportunities analytic.

34. A tool comprising:
an analytic engine for processing at least conjoint survey data regarding at least one brand and for grouping the processed data according to a plurality of marketing analytics; and
a presentation engine for displaying the marketing analytics based on a user selection.

35. The tool of claim 34, wherein the presentation engine is utilized to perform simulations based on at least one marketing analytic.

36. The tool of claim 34, wherein the marketing analytics include at least one of a utility analytic, a trend analytic, an attribute importance analytic, a competitive advantages and opportunities analytic, and an improvement opportunities analytic.

37. The tool of claim 34 wherein the analytic engine processes at least one of traditional survey data, company profitability data, market share data, consumer behavioral data and product catalog data.
